(19) United States
(12) Patent Application Publication
(10) Pub. No.: US 2015/0058136 A1
(43) Pub. Date: Feb. 26, 2015

(54) ATTRIBUTE BASED COUPON PROVISIONING

(71) Applicant: YP Intellectual Property LLC, Tucker, GA (US)

(72) Inventors: Mehul Jain, Foster City, CA (US); David Lothele Williams, Menlo Park, CA (US); Rohan Koduvayur Krishnan Chandran, Sunnyvale, CA (US); Dhiraj Sharda, Fremont, CA (US)

(21) Appl. No.: 14/468,120

(22) Filed: Aug. 25, 2014

Related U.S. Application Data
(60) Provisional application No. 61/869,402, filed on Aug. 23, 2013.

(51) Int. Cl. G06Q 30/02

(52) U.S. Cl. CPC G06Q 30/0269
USPC 705/14.66

(57) ABSTRACT

Techniques for ranking electronic coupons include associating a product category and coupon attributes with a coupon. A coupon request, including request attributes, is received and a product category of the coupon request is determined from a first attribute subset of the request attributes. The coupon is retrieved based on the product category of the request. A second attribute subset of the request attributes is identified that is unique from the first subset, and each attribute in the second subset has a respective coupon attribute. For each attribute in the second subset, a weight is assigned and the attribute is compared to its respective coupon attribute. A relevancy rank is determined for the retrieved coupon based on the weight and the comparison of attributes. If it is determined that the relevancy rank is greater than or equal to a threshold, the coupon is transmitted as a response to the request.

### CROSS-REFERENCES TO RELATED APPLICATIONS

This application claims the benefit of U.S. Provisional Patent Application No. 61/869,402 filed Aug. 23, 2013, entitled “PROXIMITY- AND TIME BASED COUPON PROVISIONING,” the entire disclosure of which is hereby incorporated by reference for all purposes.

### BACKGROUND

1. The Field of the Invention

The present invention generally relates to electronic coupons. More specifically, the present invention relates to determining relevant electronic coupons that are targeted to a user based on tracked and gathered information.

2. The Relevant Technology

Coupons can be a powerful form of advertising because the discounts provided by coupons are an attractive incentive to new and existing customers. Electronic coupons improve on traditional print coupons in many ways, the main advantage being that a broad audience can be reached for a relatively low cost. Electronic coupons can be easily distributed through multiple channels, including email, web page, social media, and mobile advertising. However, the ease of distribution also has downsides, including a decrease in effectiveness due to the sheer number of electronic coupons that a user receives. The problem is so pervasive that the label “spam” is commonly applied to much of electronic coupons.

One way of increasing the effectiveness of the electronic coupons is by targeting specific users. For example, by examining the contents of a user's email messages, a certain electronic coupon relating to the contents can be sent to the user. In another example, an electronic coupon can be displayed on a web page that relates to the contents of the web page. By targeting the electronic coupons to users that have an interest in the product being promoted, the probability that a user will redeem the electronic coupon increases.

### BRIEF SUMMARY

In one embodiment, a system for ranking a plurality of electronic coupons to determine at least one relevant electronic coupon is presented. The relevant electronic coupon is targeted to a coupon request that includes a plurality of request attributes. The system includes a network attached storage, a first computer server, and a second computer server.

The network attached storage is configured to store a plurality of entity specific profiles, each entity specific profile includes an associated entity and at least one product category indicating the type of good or service offered by the associated entity. The network attached storage is further configured to store the plurality of electronic coupons, each electronic coupon being issued for an entity and includes embedded logic for redeeming the electronic coupon from the entity.

The first computer server includes a first network interface and a first computer processor coupled to the first network interface. The first network interface is coupled to a network that includes the network attached storage. The first network interface is configured to transmit data to and receive data from the network. The first computer processor is configured to receive an electronic coupon issued by an entity, associate a product category and a plurality of coupon attributes with the electronic coupon, and transmit the electronic coupon including the product category and the plurality of coupon attributes to the network attached storage.

The second computer server includes a second network interface and a second computer processor coupled to the second network interface. The second network interface is coupled to the same network as the first network interface and is configured to transmit data to and receive data from the network. The second computer processor is configured to receive a coupon request that includes a plurality of request attributes. The plurality of request attributes further includes a plurality of past attributes derived from a user history and a plurality of current attributes. The second computer processor is further configured to determine from a first attribute subset of the plurality of request attributes that the coupon request is associated with a product category and retrieve a category subset of the plurality of electronic coupons from the network attached storage, each electronic coupon in the category subset being associated with the product category. The second computer processor is further configured to identify a second attribute subset of the plurality of request attributes, the second attribute subset being unique from the first attribute subset. Each request attribute in the second attribute subset has a respective coupon attribute in the plurality of coupon attributes associated with a retrieved electronic coupon. The second computer processor is further configured to assign a weight to each request attribute in the second attribute subset, compare each request attribute in the second attribute subset to its respective coupon attribute in the plurality of coupon attributes, and determine a relevancy rank between the electronic coupon and the coupon request. The relevancy rank is determined based on the weight assigned to each request attribute in the second attribute subset and the comparison of each request attribute in the second attribute subset to its respective coupon attribute in the plurality of coupon attributes. The second computer processor is further configured to compare the relevancy rank to a relevancy threshold, determine that the relevancy rank is greater than or equal to the relevancy threshold, and transmit the electronic coupon as a response to the coupon request based on determining that the relevancy rank is greater than or equal to the relevancy threshold.

In another embodiment, a method is presented for ranking a plurality of electronic coupons to determine at least one relevant electronic coupon. The relevant electronic coupon is targeted to a coupon request that includes a plurality of request attributes. The method includes storing a plurality of electronic coupons in a storage device, each electronic coupon being issued for an entity and includes embedded logic for redeeming the electronic coupon from the entity. A product category and a plurality of coupon attributes are associated with each of the plurality of electronic coupons, the product category indicates a type of good or service offered by the associated electronic coupon.

The coupon request that includes the plurality of request attributes is received, the plurality of request attributes including a plurality of past attributes derived from a user history and a plurality of current attributes. It is determined from a first attribute subset of the plurality of request attributes that the coupon request is associated with a first product category. A first electronic coupon that is associated with the first product category is retrieved from the storage device, the first electronic coupon also being associated with a first plurality of coupon attributes. A second attribute subset of the plurality of request attributes is identified. The second attribute subset is unique from the first attribute subset and each request attribute in the second attribute subset has a respective coupon attribute in the first plurality of coupon attributes associated with the first electronic coupon. A weight is assigned to each request attribute in the second attribute subset and each request attribute is compared to its respective coupon attribute in the first plurality of coupon attributes. A relevancy rank between the first electronic coupon and the coupon request is determined based on the weight assigned to each request attribute in the second attribute subset and the comparison of each request attribute in the second attribute subset to its respective coupon attribute in the first plurality of coupon attributes. It is determined that the relevancy rank is greater than or equal to a relevancy threshold, and the first electronic coupon is transmitted as a response to the coupon request based on determining that the relevancy rank is greater than and equal to a relevancy threshold.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of one embodiment of an attribute based coupon provisioning system.

FIG. 2 is a block diagram of one embodiment of a user device for interacting with an attribute based coupon provisioning system.

FIG. 3 is a flowchart illustrating one embodiment of a process for generating user preference information.

FIG. 4 is a flowchart illustrating one embodiment of a process for attribute based coupon provisioning.

FIG. 5 is a flowchart illustrating one embodiment of a process for generating a demand curve and adding an electronic coupon to the system.

FIG. 6 is an exemplary environment for implementing one embodiment of an attribute based coupon provisioning system.

FIG. 7 is an embodiment of a special-purpose computer system for implementing attribute based coupon provisioning.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

An electronic coupon is one of many forms of online advertising. An electronic coupon provides a discount on a specific product being offered and also includes embedded logic for redeeming the coupon. In some embodiments, the embedded logic can provide a hyperlink to a web page where the offered product can be purchased and the coupon can be applied. In other embodiments, the embedded logic includes or generates a code for the discount, or is a hyperlink to a web page that includes the code. In yet another embodiment, the embedded logic can be a hyperlink that allows the user to print the coupon or takes the user to a web page where the coupon can be printed.

Targeted electronic coupons can significantly improve redemption rates by gathering information from the online activities of a user. The gathered information is used to select certain electronic coupons that will be of interest to the user. The amount of user information that can be gathered is constantly increasing as more products and services become available online and users perform more online activities. However, gathering more information does not always lead to more effective distribution of the electronic coupons. Too much information can be overwhelming and inconsistent, which can reduce the quality of the electronic coupons that are selected for a user.

The embodiments of the invention described herein below overcome the disadvantages of the prior art by providing a method and system that use attributes to identify targeted electronic coupons. In some embodiments, a user profile is developed by tracking and gathering user information including redeemed coupons, movement data, searches, and viewed search results. This information is analyzed to generate user preferences. Attributes associated with a user or coupon request can include generated preferences as well as other information, such as the location of the user or a category of coupons that is selected by the user. In some embodiments, respective attributes are also associated with stored electronic coupons. The user or coupon request attributes are compared with the attributes of each electronic coupon to identify the most relevant coupons for the user.

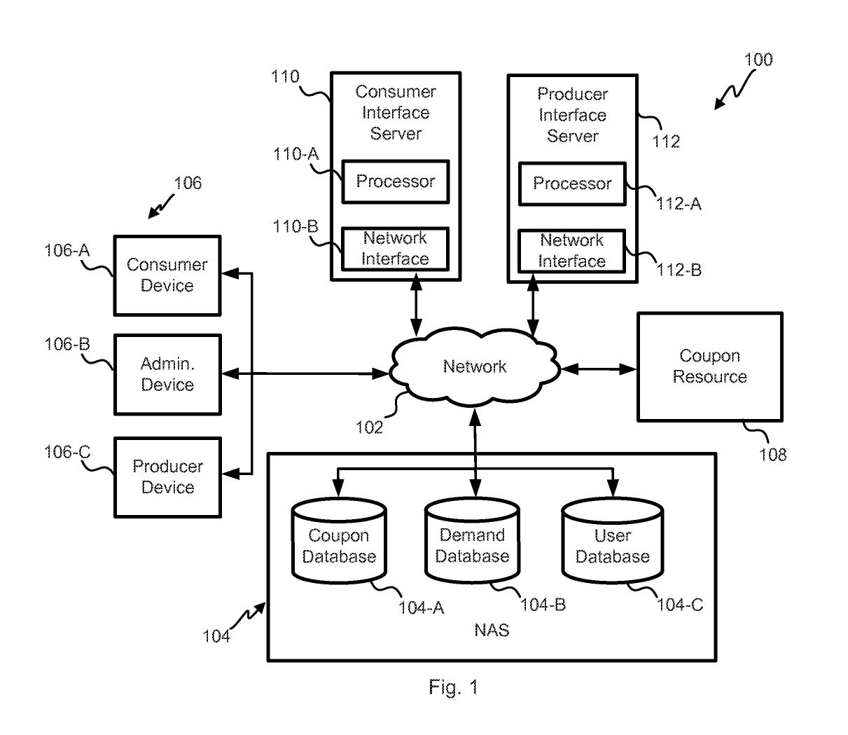

FIG. 1 is a block diagram of one embodiment of an attribute based coupon provisioning system 100. The coupon provisioning system 100 collects, receives, and stores user specific profile data and uses this profile data to select and recommend electronic coupons for the user. In some embodiments, the coupon provisioning system 100 can compare the user specific profile data with the one or several electronic coupons to determine if the coupons coincide with the user's profile and request. The coupon provisioning system 100 can provide electronic coupons to the user that coincide with the user's profile data and request attributes.

The coupon provisioning system 100 can include several different components that communicate with each other through a network 102. The network 102 can be, for example, a local area network (LAN), a wide area network (WAN), a wired network, wireless network, a telephone network such as, for example, a cellphone network, the Internet, the World Wide Web, or any other desired network. The network 102 can use any desired communication and/or network protocols.

The coupon provisioning system 100 can include one or several databases in a network attached storage (NAS) 104 that comprises stored data for the coupon provisioning system 100. NAS 104 can be any type of storage device that is accessible over a network, including a storage area network (SAN).

NAS 104 includes a coupon database 104-A that stores data relating to one or several electronic coupons, including the embedded logic for redeeming the coupons. In some embodiments, coupon database 104-A can also include data relating to vouchers, certificates, discounts, new items and/or services, or any other offer or offering. The coupon database 104-A also includes one or more product categories and coupon attributes that are associated with each electronic coupon. The product category indicates the type of product, which can be a good or a service, offered by the electronic coupon or the entity that the coupon was issued for. Coupon attributes can include information such as the entity that the electronic coupon is issued for, the location where the coupon can be redeemed, the timeframe in which the electronic coupon is valid, the brand of the product being offered, amenities of the product, price class, environmental attribute, do-it-yourself (DIY) attribute that indicates the amount of skill or work required from the user, a ranking or rating of the coupon based on feedback from other users who have either previously redeemed the coupon or have experience with the entity that the coupon is issued for, and/or any other coupon attributes that include information relevant to the electronic coupon. In one embodiment, the coupon attributes associated with each electronic coupon can differ depending on the product category associated with the coupon. The attributes can be inputted by a user of an entity for which the coupon is issued for using a user interface. In other embodiments, the attributes are generated based on information received from the user. The electronic coupons can be stored or indexed according to the product categories associated with each electronic coupon.

The NAS 104 can include a demand database 104-B. The demand database 104-B can include demand information that is based on the aggregate of information collected by the coupon provisioning system 100. This information can identify demand based on, for example, groups of consumers, location, time, date, and/or offered products, including goods and services. In some embodiments, the demand database 104-D can be accessible to one or several users of a coupon issuing entity or an entity for which a coupon is issued for to determine whether to generate an electronic coupon and/or the likelihood of success of an electronic coupon. In some embodiments, this information can be freely accessible to the user or can be used to generate a demand report that can be provided to the user.

The coupon provisioning system 100 can include a user database 104-C. The user database 104-C can include user specific profiles that contain information associated with the user, and can specifically provide account data. In some embodiments, the coupon provisioning system 100 can be used by a consuming user that receives and redeems electronic coupons. The coupon provisioning system 100 can also be used by a user of a providing entity that provides electronic coupons to the coupon provisioning system 100. In some embodiments, the user database 104-C can include account information for both a consuming user and/or a providing user.

In some embodiments, the user database 104-C can comprise login information. This can include information identifying a user such as a username and password or a user identification number. In some embodiments, when a user accesses the coupon provisioning system 100, the user is prompted to enter identification information such as a username and password. After the user provides the identification information, the coupon provisioning system 100 can verify the identification information by comparing the user provided identification information to information stored within the user database 104-C to determine if the user is an authorized user. In some embodiments, this verification can be performed by the consumer interface server 110 or the producer interface server 112, depending on which type of user is accessing the coupon provisioning system 100.

In some embodiments, the user database 104-C can comprise preference information for consuming users. This information can include a user specific profile that includes one or several preferences relating to electronic coupons. These preferences can represent user likes and/or dislikes and can be generated via the interactions of the user with the coupon provisioning system 100 and/or collected from other information sources. The preference information can include data relating to coupons that been redeemed by the user, coupons that have been accepted by the user, searches performed by the user, the user's location metadata including data identifying the user's movement patterns according to time and/or date, locations frequented by the user, attributes of electronic coupons redeemed by and/or locations visited by the user, electronic coupons dismissed by the user, and/or any other information indicative of a user preference.

In some embodiments, the user database 104-C can provide information relating to the entity that issued electronic coupons or the entity that the electronic coupons are issued for. This information can include information relating to past electronic coupons issued by or for the entity such as the success rate of past issued coupons, the number of consuming users to receive a coupon, the number of consuming users who redeemed a coupon, and/or the number of consuming users who dismissed a coupon. In some embodiments, this information can include attributes of consuming users who received, accepted, and/or dismissed the electronic coupon. In some embodiments, the user database 104-C can include recommendation information during the creation of electronic coupons to help ensure that a desired number of consuming users will redeem the coupons.

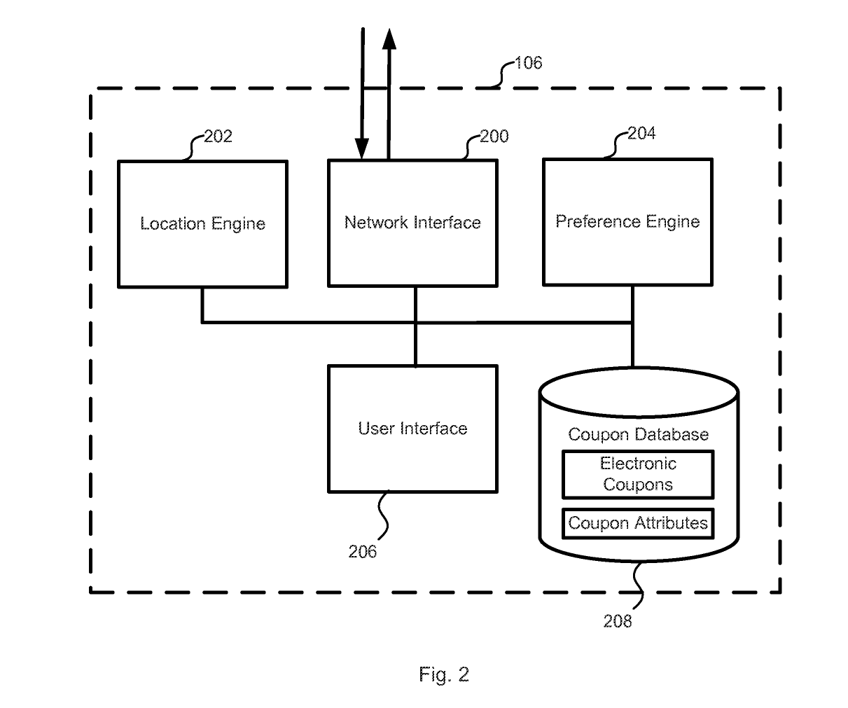

The coupon provisioning system 100 can include one or several user devices 106, such as a consumer device 106-A, an administrator device 106-B, and/or a provider device 106-C. The user devices 106 allow a user, including a consuming user, a providing user, and/or an administrator to access the coupon provisioning system 100. In some embodiments, the coupon provisioning system 100 can comprise one or several of each of the user devices 106 including, for example, one or several consumer devices 106-A, one or several administrator devices 106-B, and/or one or several producer devices 106-C. The details and function of the user devices 106 will be discussed at greater length in reference to FIG. 2 below.

The coupon provisioning system 100 can include a coupon resource 108. The coupon resource 108 can be the source of one or several electronic coupons, can be the source of some or all of the consuming user specific preference information, and/or a source of providing user information. Thus, in some embodiments, the coupon resource 108 can comprise a third party electronic coupon issuer and/or coupon aggregator, and in some embodiments, the coupon resource 108 can comprise any source of information relating to the consuming user and/or the providing user. For example, information such as a consuming user's likes, dislikes, friends, location, work time, income, education level, and/or any other information relating to the consuming user or indicating a preference for the consuming user can be received from the coupon resource 108. In some embodiments, the coupon resource 108 can comprise an online source of public information and/or any other source of information including social media. In some embodiments, the coupon resource 108 can comprise any source of information relating to the providing user. This can include information provided by the providing user, and/or information relating to the providing user. For example, coupon resource 108 can comprise the collection of information aggregated from social media websites relating to the providing user or provided by sources other than the providing user.

The coupon provisioning system 100 can include a consumer interface server 110. Consumer interface server 110 further includes a processor 110-A and a network interface 110-B. The processor 110-A can provide instructions to and receive information from the other components of the coupon provisioning system 100 through network interface 110-B. The processor 110-A can act according to stored instructions, which stored instructions can be located in memory associated with the processor and/or in other components of the coupon provisioning system 100. The processor 110-A can comprise a microprocessor, such as a microprocessor from Intel® or Advanced Micro Devices, Inc.®, or the like. Network interface 110-B can be a wired or wireless interface that facilitates communication with network 102.

In one embodiment, consumer interface server 110 handles all interactions with a consuming user interface, which can be a web interface, a native mobile device interface, or any other interface that allows a user to interact with coupon provisioning system 100. The consuming user interface can be executed by consumer device 106-A. In one embodiment, the consumer user interface generates a coupon request when the consuming user opens the interface. In other embodiments, the coupon request is generated when the consuming user performs a coupon search or presses a button in the consumer user interface. The coupon request is transmitted over network 102 and received by network interface 110-B. Processor 110-A then processes the coupon request according to any of the embodiments described herein, and returns relevant electronic coupons in response to the request via network interface 110-B and network 102. Consumer interface server 110 can process any number of coupon requests from any number of consuming users.

The coupon provisioning system 100 can include a producer interface server 112. Producer interface server 112 further includes a processor 112-A and a network interface 112-B. The processor 112-A can provide instructions to and receive information from the other components of the coupon provisioning system 100 through network interface 112-B. The processor 112-A can act according to stored instructions, which stored instructions can be located in memory associated with the processor and/or in other components of the coupon provisioning system 100. The processor 112-A can comprise a microprocessor, such as a microprocessor from Intel® or Advanced Micro Devices, Inc.®, or the like. Network interface 112-B can be a wired or wireless interface that facilitates communication with network 102.

In one embodiment, producer interface server 112 handles all interactions with a providing user interface. The providing user interface can be executed by producer device 106-C. The providing user interface can be used by a providing user of an electronic coupon issuing entity to add new coupons to the coupon provisioning system 100, modify existing coupons, or view demand information. A request can be generated for each interaction, which is transmitted over network 102 and received by network interface 112-B. Processor 112-A then processes the request according to any of the embodiments described herein, and if needed, returns data in response to the request via network interface 112-B and network 102.

FIG. 2 is a block diagram of one embodiment of a user device 106. As discussed above, the user device 106 can be configured to provide information to and receive information from other components of the coupon provisioning system 100. The user device 106 can access the coupon provisioning system 100 through any desired means or technology, including a web page such as a social network service page or a web portal. As depicted in FIG. 2, the user device 106 can include a network interface 200. The network interface 200 allows the user device 106 to access the other components of the coupon provisioning system 100, and specifically allows the user device 106 to access the network 102 of the coupon provisioning system 100. The network interface 200 can include features configured to send and receive information, including an antenna, a modem, a transmitter, a receiver, or any other feature that can send and receive information. The network interface 200 can communicate via telephone, cable, fiber-optic, or any other wired communication network. In some embodiments, the network interface 200 can communicate via cellular networks, WLAN networks, or any other wireless network.

The user device 106 can include location engine 202. The location engine 202 can identify or facilitate in identifying the location of the user. In some embodiments in which the user device 106 comprises a mobile device such as a smart phone or tablet, the location engine 202 can comprise integrated components and/or functionalities of the smart phone or tablet such as a GPS, Magellan antenna, and/or Magellan capability. In some embodiments, the information generated by the location engine 202 can be provided to other components of the coupon provisioning system 100 such as the user database 104-C to store the user location.

The user device 106 can include a preference engine 204. The preference engine 204 can facilitate in compiling user information to generate a user profile and can be configured to apply the user profile to available electronic coupons. In some embodiments, the preference engine 204 can be configured to aggregate user data from multiple sources within the coupon provisioning system 100 and to generate a user profile with this information. In some embodiments, the preference engine 204 can be configured to aggregate user data from the coupon resource 108. In some embodiments, the preference engine 204 can include integral and/or separate search functionalities that allow the user to search for specific electronic coupons, services, and/or goods. In some embodiments, the preference engine 204 can use this information relating to user searches and/or relating to selected search results to generate all or portions of the user profile. In some embodiments, the search results generated by the reference engine 204 can be filtered based on pre-existing user preferences.

In some embodiments, the preference engine can be configured to receive user profile information from the user database 104-C and coupon information from the coupon database 104-A and/or demand database 104-B, and use this information to identify and/or indicate electronic coupons coinciding with user preferences and/or to indicate demand coinciding with a providing user's potential electronic coupon. In some embodiments, this determination of coupons coinciding with user preference and/or demand coinciding with user's potential coupon can be determined according to one or several preference rules and/or association rules that can be stored in one of the databases 104 of the coupon provisioning system 100.

The user device 106 can include a user interface 206 that communicates information to and receives inputs from a user. The user interface 206 can include a touchscreen, a speaker, a monitor, a keyboard, a microphone, a mouse, a touchpad, a keypad, or any other feature or features that can receive inputs from a user and provide information to a user.

In some embodiments, the user device 106 can include a coupon database 208. The coupon database 208 can include information relating to available electronic coupons, accepted coupons, saved coupons, and/or dismissed coupons. The coupon database 208 can also include the coupon attributes for each electronic coupon that is stored in the database. In some embodiments, the coupon database 208 can further include user profile information including, for example, consuming user preference information. This information can be received from the other components of the user device 106 or the other components of the coupon provisioning system 100. In some embodiments, this information can be provided to the other components of user device 106 or to the other components of the coupon provisioning system 100. In some embodiments, this information can be updated from the coupon database 104-A or user database 104-C. The information can also be used to update the user database 104-C.

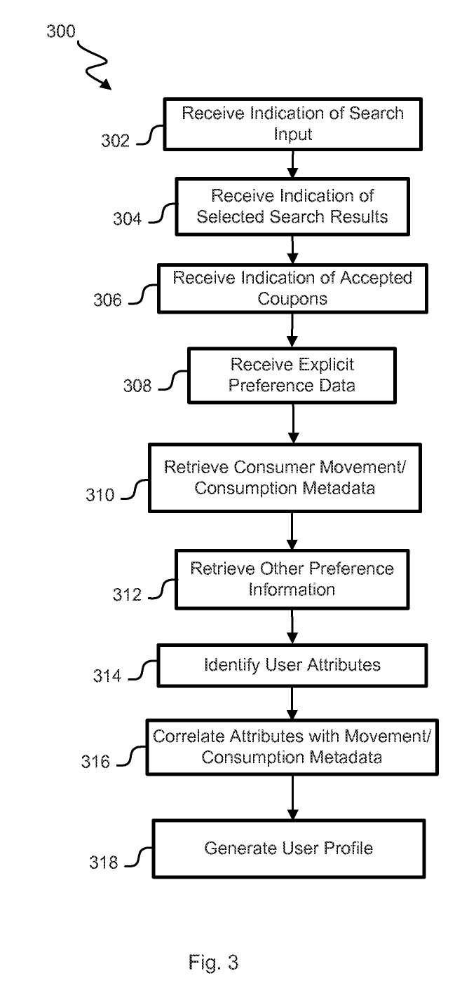

FIG. 3 is a flowchart illustrating one embodiment of a process 300 for generating user preference information. In some embodiments, this process 300 can be performed to generate user preference information for storage within the user database 104-C or within the coupon database 208. This process can be performed by the coupon provisioning system 100 or a component of the coupon provisioning system 100.

The process 300 begins at block 302, wherein an indication of a search input is received. In some embodiments, this search input can be provided by the user via the preference engine 204 and can be a search for one or several electronic coupons, goods, demand, and/or services. After the indication of the search input is received, the process 300 proceeds to block 304 wherein an indication of selected search results is received. In some embodiments, the selected search results can coincide to hits resulting from the user provided search terms that were selected by the user. In some embodiments, the preference engine 204 can include rules for determining when the result of a search has been selected. In some embodiments, the selection of a search result can be defined such that any result that is clicked upon or opened is selected. In other embodiments, a search result is only selected when it is opened for a certain amount of time or when any other desired criteria is met.

After the indication of the selected search results has been received, the process 300 proceeds to block 306 wherein an indication of one or several accepted electronic coupons is received. In some embodiments, an accepted electronic coupon can coincide with an electronic coupon that has been selected and redeemed by the consumer. Specific information regarding the redemption of the electronic coupons can also be received, including web pages that were visited or phone numbers that were called by the consumer to redeem the coupons. In some embodiments, this block 306 can further include receiving an indication of coupons that have been saved for future viewing, coupons received and dismissed by the consuming user, and/or coupons received by the user for which no action was taken. In some embodiments, information relating to accepted and/or saved coupons can be stored within the user device 106, such as the coupon database 208, or within the coupon provisioning system 100, such as the demand database 104-B or the user database 104-C.

After the indication of accepted coupons has been received, the process 300 proceeds to block 308 wherein explicit reference data is received. In some embodiments, as part of the creation of the user data stored within the user database 104-C, the user can enter information indicating or identifying one or several user preferences. This information can identify the types of coupons, goods, services, or demand in which the user is interested, the locations, dates, and times of user consumption, or any other desired information such as the user's home location. This information can be entered via the user interface 206 and stored within one of the databases 104 of the coupon provisioning system 100 such as the user database 104-C or within the coupon database 208 of the user device 106.

After explicit preference data has been received, the process 300 proceeds to block 310 wherein user movement or consumption metadata is received. In some embodiments, this information can correspond to information identifying the user location according to date, time, or any other desired parameter. In some embodiments, this information can further include information indicating coupons, goods, and/or services consumed by the user according to location, date, and/or time. In some embodiments, this information can be generated by the location engine 202 or the preference engine 204 and can be aggregated in one of the databases 104 of the coupon provisioning system 100 such as the user database 104-C or in the coupon database 208 of the user device 106.

After consumer movement or consumption metadata has been retrieved, the process proceeds to block 312 wherein other preference information is retrieved. In some embodiments, this can include retrieving information from one or more online resources including one or several web pages such as a social media web page, a credit card or banking web page, or a good or service provider web page. This information can be retrieved and stored in one of the databases 104 of the coupon provisioning system 100 such as the user database 104-C or the coupon database 208.

After the preference information has been retrieved, the process 300 proceeds to block 314 wherein user attributes of the data aggregated in blocks 302 to 312 are identified. In some embodiments, this process can be performed by the preference engine 204 of the user device 106 and can include identifying cross-information attributes which can be user attributes occurring in multiple product categories or multiple times within a single product category. In some embodiments, these cross-information attributes can include, for example, types of cuisine, goods and/or services, preferred entities or brands, amenities, price class, environmental attributes, DIY attributes that indicates the amount of skill the user possesses or the amount of work the user prefers to perform, and/or any other common attribute arising in the above aggregated data. In some embodiments, the user attributes can be stored within one of the databases 104 of the coupon provisioning system 100 such as the user database 104-C or can be stored within the coupon database 208 of the user device 106.

After user attributes have been identified, the process 300 proceeds to block 316, wherein the user attributes are correlated with the movement or consumption metadata. The correlation of user attributes with the movement or consumption data can include identifying the location, date, and/or time parameters associated with the user attributes. This process can be performed by the preference engine 204, and the results of this correlation can be stored within the user database 104-C or in the coupon database 208.

After the user attributes are correlated with the movement or consumption metadata, process 300 proceeds to block 318 wherein a user specific profile is generated. The user specific profile can be generated according to the amount or detail of information aggregated in blocks 302 to 312, and thus can provide varying degrees of certainty or completeness. In some embodiments, the user specific profile can comprise a list of user attributes sorted, weighted, or listed according to location, date, and/or time of relevance. In some embodiments, the user specific profile can be stored within the user database 104-C or within the coupon database 208.

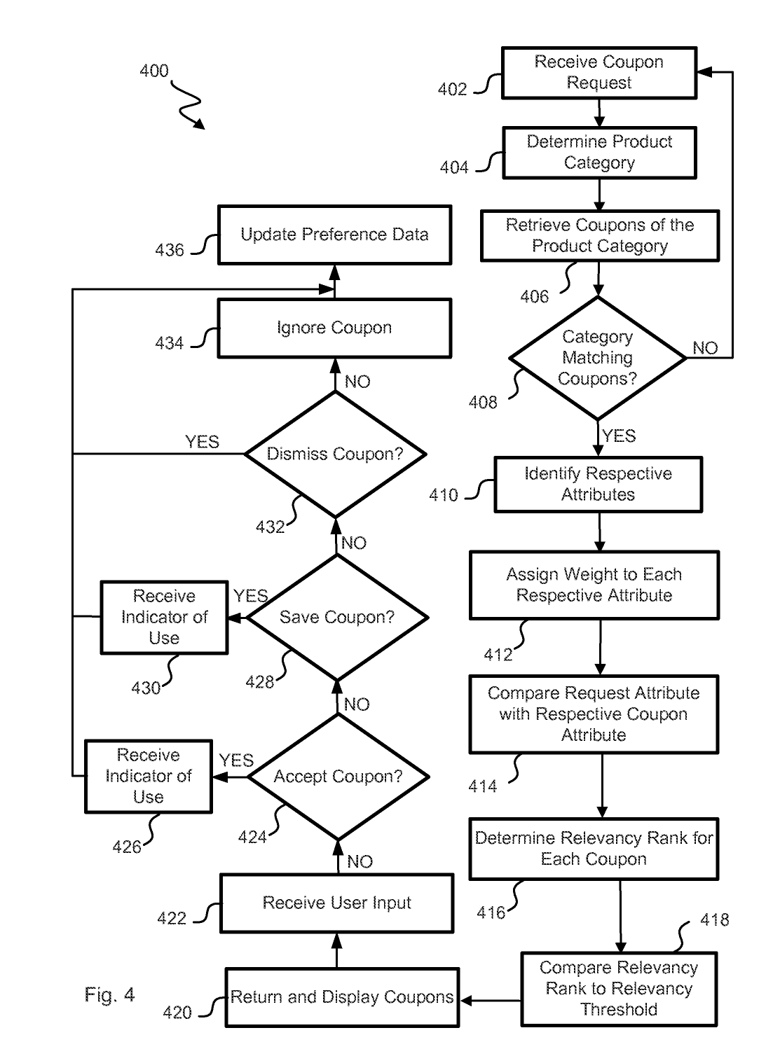

FIG. 4 is a flowchart illustrating one embodiment of a process 400 for attribute based coupon provisioning. In some embodiments, this process 400 can be performed to rank and determine which electronic coupons are relevant to a user, and/or to determine which coupons to provide to a user such as a consuming user. This process can be performed by the coupon provisioning system 100 or a component of the coupon provisioning system 100 such as the consumer interface server 110. In other embodiments, this process can be performed by the user device 106.

The process begins at block 402 wherein a coupon request, including a plurality of request attributes, is received. The request attributes can contain information specific to the current coupon request. For example, request attributes specific to the current request can include a product category indicating a type of good or service that is of interest to the user that was selected by the user in a user interface. Current request attributes can also include location information and date and time information. The information can be generated by the user device 106 or a component of the user device 106, such as the location engine 202, and is received by the consumer interface server 110 and/or another component of the coupon provisioning system 100. The request attributes can also include past attributes derived from the user history or preference information, such as any of the user attributes identified in process 300. In some embodiments, the past attributes are received separately from the current request attributes. For example, the past attributes can be retrieved from the user database 104-C after receiving the coupon request.

After the coupon request has been received, the process 400 proceeds to block 404 wherein the product category is determined from the request attributes. The product category can determined from a subset of the request attributes, for example the current request attributes. In one embodiment, the product category attribute is always located at a certain position among the request attributes that are received with the coupon request. For example, the product category attribute can always be the first request attribute that is received. In other embodiments, each request attribute can be tagged, and the product category attribute can be located by examining the tag of each request attribute. Once the product category attribute has been located, the product category can be extracted from the attribute.

Process 400 then proceeds to block 406 to retrieve electronic coupons associated with the same product category as the coupon request. For example, the electronic coupons can be retrieved from one of the databases 104 such as the coupon database 104-A by transmitting a query for the product category to the database. In one embodiment, the electronic coupons stored in the database are grouped by or indexed by the product category, and all electronic coupons associated with the particular product category can be easily identified. In other embodiments, the product category of each electronic coupon stored in the database is examined to identify all coupons associated with the product category. In some embodiments, the electronic coupons retrieved can be further limited based on other current request attributes. For example, by using the location or time attributes, the system can only retrieve electronic coupons that are currently active and can be redeemed within a range of the location, for example in the same city.

The process 400 then proceeds to block 408 to determine if any matching electronic coupons have been retrieved. If the system failed to retrieve any electronic coupons associated with the same product category as the coupon request, or, in some embodiments, if the system failed to retrieve active coupons of the same product category and within a range of the current location, the process 400 returns to block 402. This determination can be performed by the consumer interface server 110 or by the preference engine 204.

If it is determined that there are category matching coupons, the process 400 proceeds to block 410 to identify request attributes of the coupon request with respective coupon attributes of the electronic coupons retrieved at block 406. For example, a location attribute of the coupon request indicating a current user location can have a respective location attribute for each electronic coupon retrieved indicating a location where the coupon can be redeemed. Other respective attributes can include types of cuisine, goods and/or services, entities or brands, amenities, price class, environmental attributes, and DIY attributes. Thus, for each request attribute identified in block 410, there is at least one retrieved electronic coupon with a respective attribute. The respective attributes can be identified from a second subset of the request attributes that is unique from the subset that the product category was determined from.

After the respective attributes have been identified, the process 400 proceeds to block 412 wherein a weight is assigned to each request attribute identified in block 410. In some embodiments, the weight assigned to each request attribute is based on the user preference information generated in process 300. For example, if a DIY attribute for a particular user specific profile occurs more often in the user history than a price range attribute, more weight can be assigned to the DIY attribute relative to the weight assigned to the price range attribute. The data that is included in one or more request attributes can also affect the weight assigned to other request attributes. For example, if a user's current location is beyond a range of the user's home location (e.g., outside of the user's home city or state), and the user has indicated an interest in a product that is usually consumed in a short period of time, such as food, then more weight can be assigned to the current location relative to the weight assigned to the home location or other request attributes. The weight assigned to each attribute can also depend on group preferences. For example, multiple user specific profiles can be grouped based on common attributes, such as the age or location of each user in the group. Additional weight can be assigned to, for example, a brand attribute if users in a certain age group have a strong preference for brands, or a price range attribute if users in a certain location group have a strong preference for price. In some embodiments, the weight is assigned during process 300 as the user preference information is generated or updated, and the weight is retrieved during block 412 from, for example, the user database 104-C or the coupon database 208.

At block 414, the request attributes identified in block 410 are compared to their respective coupon attributes for each coupon retrieved in block 406. In one embodiment, a match value or score is determined for each comparison. For example, if the request attribute and its respective coupon attribute is a location attribute, then the match value or score can be inversely related to the distance between the request location and the coupon location, such that a higher score indicates a shorter distance. In some embodiments, the match value or score can be a binary function, such as a 1 if there is a match and a 0 if there is no match.

At block 416, a relevancy rank is determined for each electronic coupon using the weight assigned to each request attribute in block 412 and the results of the comparisons from block 414. In one embodiment, the relevancy rank is determined using a function that takes as input the weighting and the results of the comparisons. For example, a relevancy rank for a particular electronic coupon can be determined by taking the product of a weight of a request attribute and the comparison result from comparing the request attribute to its respective coupon attribute, then taking the sum of that product for each request attribute identified in block 410 for the particular electronic coupon. This process can be repeated for each electronic coupon retrieved in block 406 to determine a relevancy rank for each coupon. A relevancy rank can be a rating, a score, or any other form of ranking the electronic coupons.

At block 418, the relevancy ranks of the electronic coupons are compared to a relevancy threshold to determine which coupons are returned in response to the coupon request. In one embodiment, this is done by sorting the electronic coupons by the relevancy rank, in which case the threshold for the relevancy rank of one electronic coupon would be the relevancy rank of another electronic coupon. In other embodiments, this comparison can be performed according to a binary function and a threshold value. In such an embodiment, any electronic coupon having a relevancy rank exceeding the relevancy threshold can be indicated by a first value, ones that do not exceed the relevancy threshold can be indicated by a second value. In such an embodiment, electronic coupons indicated by the first value are returned and displayed to the user. In some embodiments, electronic coupons can be displayed to the user according to the relevancy rank after sorting, for example, in descending order.

Process 400 then proceeds to block 420 wherein the relevant electronic coupons are transmitted back to the user device 106 and displayed to the user. In some embodiments, all electronic coupons retrieved in block 406 are returned and displayed to the user, along with their respective relevancy ranks. In some embodiments, the coupons are transmitted via network interface 110-B and network 102 to the user device 106. The coupons can be displayed by the user interface 206 of the user device 106.

After the electronic coupons are displayed to the user, the process 400 proceeds to block 422 wherein the user input is received. In some embodiments, these inputs can be received via the user interface 206 of the user device 106. In some embodiments, an indicator of user acceptance of the electronic coupon can be stored in one of the databases 104 such as the user database 104-C and/or the coupon database 208. In some embodiments, the user input can correspond to the action taken on the electronic coupon by the user.

After the user input is received, the process 400 proceeds to decision state 424 wherein it is determined if the user accepted the coupon. In some embodiments, this determination can include an evaluation of the user input performed by the processor 110-A or the preference engine 204. If it is determined that the user accepted the electronic coupon, then the process 400 proceeds to block 426 wherein an indicator of use is received. In some embodiments, the indicator signals when the electronic coupon has been redeemed and a purchase has been made. In some embodiments, this indicator can be received by the processor 110-A of the consumer interface server 110 or by the user device 106 of the coupon provisioning system 100. In some embodiments, this indicator can be stored in one of the databases 104 such as the user database 104-C or the coupon database 208 of the user device 106.

Returning again to decision state 424, if it is determined that the electronic coupon is not accepted, then the process 400 proceeds to decision state 426 wherein it is determined if the user saved the electronic coupon. In some embodiments, an electronic coupon can be saved on the user device or another component of the coupon provisioning system 100. In some embodiments, the electronic coupon can be stored as a text, image, data, and/or object at either the user device 106 or at another component of the coupon provisioning system 100.

In some embodiments, the user input and/or the databases 104/208 are analyzed to determine if the electronic coupon was saved. If it is determined that the coupon was saved, the process 400 proceeds to block 430 wherein an indicator of use is received. In some embodiments, the coupon provisioning system 100 can include a proximity trigger that provides a reminder of a saved and/or available electronic coupon when the user is within a certain distance of the location associated with the coupon. In some embodiments, the coupon provisioning system 100 can be configured to display all coupons associated with a location when the user is at or proximate to the location. In some embodiments, the indicator of use signals that the electronic coupon has been redeemed and a purchase has been made.

Returning again to decision state 428, if it is determined that the coupon is not saved, the process 400 proceeds to decision state 432 wherein it is determined if the coupon is dismissed. In some embodiments, this determination can be performed by the processor 110-A or the preference engine 204 by evaluating the received user input. If the coupon has not been dismissed, the process 400 proceeds block 434, wherein the coupon is ignored. In some embodiments, a coupon is ignored if it has not been accepted, saved, or dismissed. The coupon provisioning system 100 can provide reminders of coupons that have been accepted, saved, or ignored and that have not yet been used. In some embodiments, these reminders can be provided until the coupon expires, with increasing frequency as the date of expiration approaches. In some embodiments, information relating to an ignored coupon can be stored in one of the databases 104 of the coupon provisioning system 100 such as the user database 104-C or the coupon database 208 of the user device 106.

After the coupon has been ignored, and returning again to blocks 426, 430, after the indicator of use has been received, the process 400 proceeds to block 436 wherein the preference data is updated. In some embodiments, for example, the preference data can be updated with information relating to whether the user accepted, saved, dismissed, used, and/or ignored an electronic coupon. In some embodiments, this information can be updated within the user database 104-C and/or the coupon database 208. Process 400 can be repeated for any number of coupon requests that are received from any number of users.

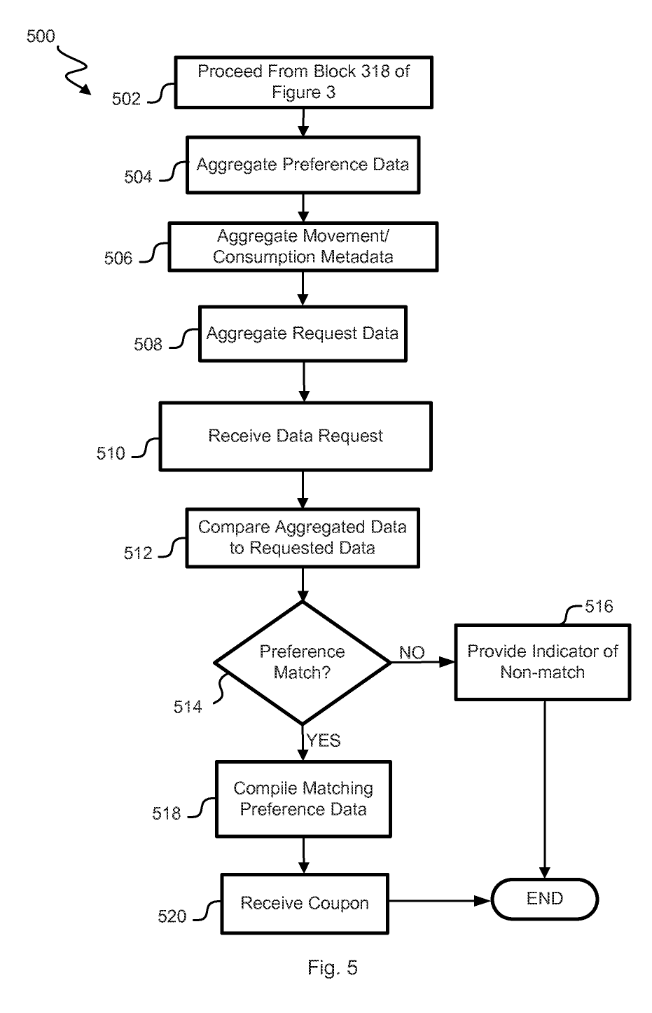

FIG. 5 is a flowchart illustrating one embodiment of a process 500 for generating a demand curve and adding an electronic coupon to the system. In some embodiments, this process 500 can be performed at the request of a providing user and/or can be performed by the providing user. In some embodiments, this process can be performed to determine the actual demand and/or potential demand for an electronic coupon generated by the providing user and/or for a hypothetical coupon. In some embodiments, this process can be performed by the coupon provisioning system 100 or a component thereof.

The process 500 begins at block 502 wherein the process 500 continues the process performed in FIG. 3, and specifically begins after block 318 of FIG. 3 has been performed. After the preference data has been generated, the process 500 proceeds to block 504, wherein the preference data is aggregated. In some embodiments, the aggregation of the preference data can comprise the collection and compilation of preference data for a group of users. In some embodiments, this group of individuals can be defined by any desired individual attribute including, for example, location data, age data, preference data, and/or consumption data.

After the preference data has been aggregated, the process 500 proceeds to block 506 wherein movement and/or consumption data is aggregated. In some embodiments, for example, this can include the collection and compilation of movement and/or consumption metadata for the same group of individuals for which the preference data was aggregated. After the movement and/or consumption data has been aggregated, the process 500 proceeds to block 508 wherein request data is aggregated. In some embodiments, the aggregation of request data can correspond to the collection and compilation of search requests and/or searches made by the individuals identified in blocks 504 and 506.

In some embodiments, blocks 504, 506, and 508 can be performed by the processor 110-A or 112-A of the coupon provisioning system 100. The results of blocks 504, 506, and 508 can be stored in one of the databases 104 of the coupon provisioning system 100 including the demand database 104-B or the coupon database 208 of the user device 106. In some embodiments, the combination of blocks 504, 506, and 508 can define a target group of individuals, the target group defined by location, date, time, and/or preference.

After the request data has been aggregated, the process 500 proceeds to block 510 wherein a data request is received. In some embodiments, the data request can be a request for a demand curve and/or for demand information. This request can be made by the providing user via, for example, the user device 106 and/or via the processor 112-A of the coupon provisioning system 100.

After the data request has been received, the process 500 proceeds to block 512 wherein the aggregated data is compared to the requested data. In some embodiments, this can include the retrieval of the aggregated data from one of the databases 104 such as the demand database 104-B. This comparison can then be performed by, for example, the processor 112-A or the preference engine 204 of the user device 106. In some embodiments, an indicator can be added to each individual represented by the aggregated data, and/or to portions of the aggregated data that match the requested data. In some embodiments, this indicator can be stored in the demand database 104-B.

After the aggregated data has been compared to the requested data, the process 500 proceeds to decision state 514 wherein it is determined if there is a preference match. In some embodiments, this determination can be performed by the processor 112-A and/or the preference engine 204, and can include the evaluation of matching indicators between the aggregated data and the requested data that can be stored in the demand database 104-B.

If it is determined that aggregated data does not match the requested data, then the process 500 proceeds to block 516 wherein an indicator of non-match is provided. In some embodiments, this indicator can be provided to the user device 106 via the network interface 200 and can be provided to the user via the user interface 206 of the user device 106.

Returning again to decision state 514, if it is determined that the aggregate data matches the requested data, then the process 500 proceeds to 518 wherein the preference data and/or the aggregated data that matches and/or corresponds to the requested data is compiled. In some embodiments, the compilation of the matching preference data can further include providing the matching aggregated data and/or preference data to the user, which can provide the user with information regarding the attributes of the group corresponding to the user request. In some embodiments, this information can be provided to the user device 106 via the network interface 200 and/or the user interface 206 of the user device 106. In some embodiments, the compilation of matching preference data can include the retrieval of the aggregated data from the demand database 104-B.

After the matching preference data has been compiled, the process 500 proceeds to block 520 wherein the electronic coupon is received. In some embodiments, the user can create and submit an electronic coupon based on the compiled matching preference data. The coupon can be received via the network interface 200 of the user device 106 and/or the coupon resource 108. In other embodiments, the coupon can be generated for the user or the providing entity based on the compiled matching preference data. In some embodiments, one or more product categories and coupon attributes are associated with the received or generated coupon. The product categories and coupon attributes can be specified by a user or generated by the coupon provisioning system 100. The received or generated coupon, including the product categories and coupon attributes associated with the coupon, can be stored in one of the databases 104 such as the coupon database 104-A. This process can be repeated for any number of coupons for any number of users.

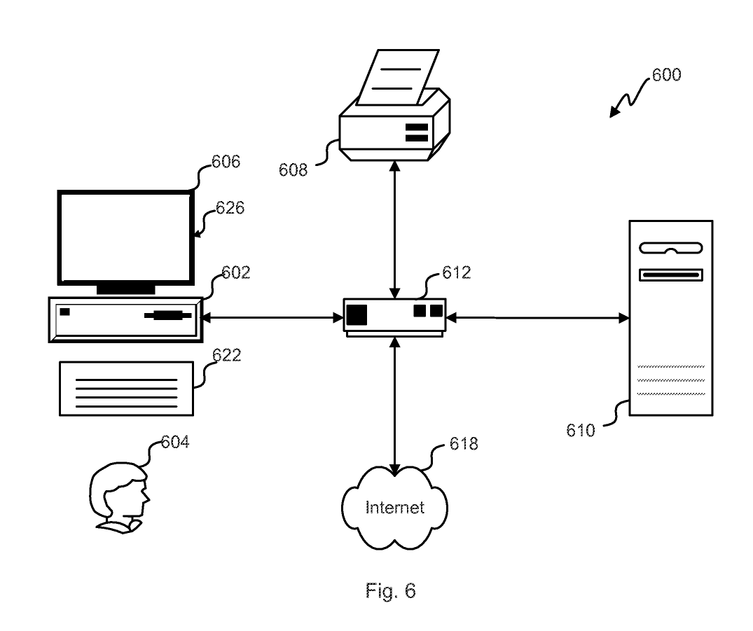

With reference now to FIG. 6, an exemplary environment with which embodiments may be implemented is shown with a computer system 600 that can be used by a user 604 as all or a component of an attribute based coupon provisioning system 100. The computer system 600 can include a computer 602, keyboard 622, a network router 612, a printer 608, and a monitor 606. The monitor 606, processor 602 and keyboard 622 are part of a computer system 626, which can be a laptop computer, desktop computer, handheld computer, mainframe computer, etc. The monitor 606 can be a CRT, flat screen, etc.

A user 604 can input commands into the computer 602 using various input devices, such as a mouse, keyboard 622, track ball, touch screen, etc. If the computer system 600 comprises a mainframe, a designer 604 can access the computer 602 using, for example, a terminal or terminal interface. Additionally, the computer system 626 may be connected to a printer 608 and a server 610 using a network router 612, which may connect to the Internet 618 or a WAN. While only one server 610 is shown in the figure, it is understand that computer system 626 may be connected to any number of servers.

The server 610 may be used to store additional software programs and data. In one embodiment, software implementing the systems and methods described herein can be stored on a storage medium in the server 610. Thus, the software can be run from the storage medium in the server 610. In another embodiment, software implementing the systems and methods described herein can be stored on a storage medium in the computer 602. Thus, the software can be run from the storage medium in the computer system 626. Therefore, in this embodiment, the software can be used whether or not computer 602 is connected to network router 612. Printer 608 may be connected directly to computer 602, in which case, the computer system 626 can print whether or not it is connected to network router 612.

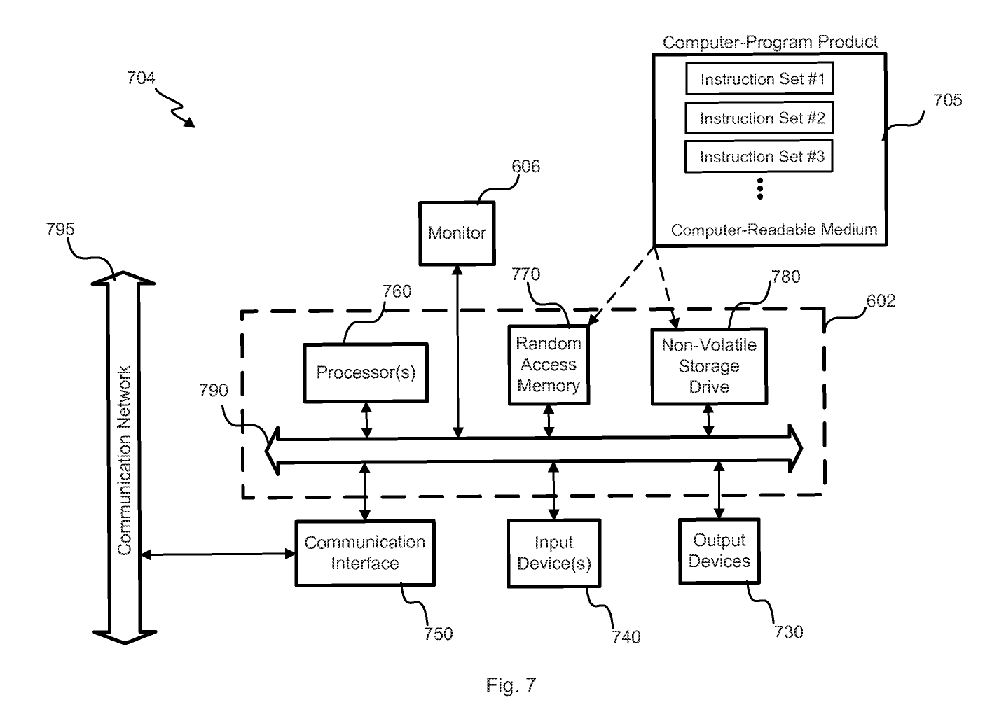

With reference to FIG. 7, an embodiment of a special-purpose computer system 704 is shown. The methods and systems described herein may be implemented by computer-program products that direct a computer system to perform the actions of the methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof.

Special-purpose computer system 704 comprises a computer 602, a monitor 606 coupled to computer 602, one or more additional user output devices 730 (optional) coupled to computer 602, one or more user input devices 740 (e.g., keyboard, mouse, track ball, touch screen) coupled to computer 602, an optional communications interface 750 coupled to computer 602, a computer-program product 705 stored in a tangible computer-readable memory in computer 602. Computer-program product 705 directs system 704 to perform the above-described methods. Computer 602 may include one or more processors 760 that communicate with a number of peripheral devices via a bus subsystem 790. These peripheral devices may include user output device(s) 730, user input device(s) 740, communications interface 750, and a storage subsystem, such as random access memory (RAM) 770 and non-volatile storage drive 780 (e.g., disk drive, optical drive, solid state drive), which are forms of tangible computer-readable memory.

Computer-program product 705 may be stored in non-volatile storage drive 780 or another computer-readable medium accessible to computer 602 and loaded into memory 770. Each processor 760 may comprise a microprocessor, such as a microprocessor from Intel® or Advanced Micro Devices, Inc.®, or the like. To support computer-program product 705, the computer 602 runs an operating system that handles the communications of product 705 with the above-noted components, as well as the communications between the above-noted components in support of the computer-program product 705. Exemplary operating systems include Windows® or the like from Microsoft® Corporation, Solaris® from Oracle®, LINUX, UNIX, and the like.

User input devices 740 include all possible types of devices and mechanisms to input information to computer system 602. These may include a keyboard, a keypad, a mouse, a scanner, a digital drawing pad, a touch screen incorporated into the display, audio input devices such as voice recognition systems, microphones, and other types of input devices. In various embodiments, user input devices 740 are typically embodied as a computer mouse, a trackball, a track pad, a joystick, wireless remote, a drawing tablet, a voice command system. User input devices 740 typically allow a user to select objects, icons, text and the like that appear on the monitor 606 via a command such as a click of a button or the like. User output devices 730 include all possible types of devices and mechanisms to output information from computer 602. These may include a display (e.g., monitor 606), printers, non-visual displays such as audio output devices, etc.

Communications interface 750 provides an interface to other communication networks 795 and devices and may serve as an interface to receive data from and transmit data to other systems, WANs and/or the Internet 618. Embodiments of communications interface 750 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 750 may be coupled to a computer network, to a FireWire® bus, or the like. In other embodiments, communications interface 750 may be physically integrated on the motherboard of computer 602, and/or may be a software program, or the like.

RAM 770 and non-volatile storage drive 780 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 770 and non-volatile storage drive 780 may be configured to store the basic programming and data constructs that provide the functionality of various embodiments of the present invention, as described above.

Software instruction sets that provide the functionality of the present invention may be stored in RAM 770 and non-volatile storage drive 780. These instruction sets or code may be executed by the processor(s) 760. RAM 770 and non-volatile storage drive 780 may also provide a repository to store data and data structures used in accordance with the present invention. RAM 770 and non-volatile storage drive 780 may include a number of memories including a main random access memory (RAM) to store of instructions and data during program execution and a read-only memory (ROM) in which fixed instructions are stored. RAM 770 and non-volatile storage drive 780 may include a file storage subsystem providing persistent (non-volatile) storage of program and/or data files. RAM 770 and non-volatile storage drive 780 may also include removable storage systems, such as removable flash memory.

Bus subsystem 790 provides a mechanism to allow the various components and subsystems of computer 602 communicate with each other as intended. Although bus subsystem 790 is shown schematically as a single bus, alternative embodiments of the bus subsystem may utilize multiple busses or communication paths within the computer 602.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A system for ranking a plurality of electronic coupons to determine at least one relevant electronic coupon, the at least one relevant electronic coupon being targeted to a coupon request including a plurality of request attributes, the system comprising:
a network attached storage configured to store:
a plurality of entity specific profiles, each entity specific profile including an associated entity and at least one product category indicating at least one of a type of good and a type of service offered by the associated entity, and
the plurality of electronic coupons, each electronic coupon being issued for an entity and including embedded logic for redeeming the electronic coupon from the entity;
a first computer server including:
a first network interface coupled to a network including the network attached storage, the first network interface configured to transmit data to and receive data from the network, and
a first computer processor coupled to the first network interface and configured to:
receive a first electronic coupon issued by a first entity,
associate a first product category and a first plurality of coupon attributes with the first electronic coupon, and
transmit the first electronic coupon including the first product category and the first plurality of coupon attributes to the network attached storage; and
a second computer server including:
a second network interface coupled to the network and configured to transmit data to and receive data from the network, and
a second computer processor coupled the second network interface and configured to:
receive a first coupon request including a first plurality of request attributes, the first plurality of request attributes including a plurality of past attributes derived from a user history and a plurality of current attributes,
determine from a first attribute subset of the first plurality of request attributes that the first coupon request is associated with the first product category,
retrieve a category subset of the plurality of electronic coupons from the network attached storage, each electronic coupon in the category subset being associated with the first product category, and the category subset including the first electronic coupon,
identify a second attribute subset of the first plurality of request attributes, the second attribute subset being unique from the first attribute subset, each request attribute in the second attribute subset having a respective coupon attribute in the first plurality of coupon attributes associated with the first electronic coupon,
assign a weight to each request attribute in the second attribute subset,
compare each request attribute in the second attribute subset to its respective coupon attribute in the first plurality of coupon attributes,
determine a relevancy rank between the first electronic coupon and the first coupon request based on the weight assigned to each request attribute in the second attribute subset and the comparing of each request attribute in the second attribute subset to its respective coupon attribute in the first plurality of coupon attributes,
compare the relevancy rank to a relevancy threshold,
determine that the relevancy rank is at least one of greater than and equal to the relevancy threshold, and
transmit the first electronic coupon as a response to the first coupon request based on determining that the relevancy rank is at least one of greater than and equal to the relevancy threshold.

2. The system for ranking the plurality of electronic coupons to determine at least one relevant electronic coupon of claim 1, wherein the network attached storage is further configured to store a plurality of user specific profiles, wherein the first coupon request is associated with a first user specific profile, wherein the second attribute subset of the first plurality of request attributes includes at least one request attribute derived from the first user specific profile, and wherein the weight assigned to each request attribute in the second attribute subset is based on the first user specific profile.

3. The system for ranking the plurality of electronic coupons to determine at least one relevant electronic coupon of claim 2, wherein the first user specific profile includes a redeemed coupons history.

4. The system for ranking the plurality of electronic coupons to determine at least one relevant electronic coupon of claim 2, wherein the first user specific profile includes a call history.

5. The system for ranking the plurality of electronic coupons to determine at least one relevant electronic coupon of claim 2, wherein the first user specific profile includes a location history.

6. The system for ranking the plurality of electronic coupons to determine at least one relevant electronic coupon of claim 2, wherein the first user specific profile includes a plurality of favorite entities.

7. The system for ranking the plurality of electronic coupons to determine at least one relevant electronic coupon of claim 6, wherein the first user specific profile further includes a ranking associated with each of the plurality of favorite entities.

8. The system for ranking the plurality of electronic coupons to determine at least one relevant electronic coupon of claim 6, wherein the first user specific profile further includes a plurality of shared entities derived from a second plurality of favorite entities in a second user specific profile that is shared with the first user specific profile.

9. The system for ranking the plurality of electronic coupons to determine at least one relevant electronic coupon of claim 1, wherein the embedded logic in each electronic coupon includes a hyperlink.

10. A method for ranking a plurality of electronic coupons to determine at least one relevant electronic coupon, the at least one relevant electronic coupon being targeted to a coupon request including a plurality of request attributes, the method comprising:
receiving a first electronic coupon issued for a first entity and a second electronic coupon issued for a second entity, each electronic coupon including embedded logic for redeeming the electronic coupon;
associating a product category with the first electronic coupon and the second electronic coupon, the product category indicating at least one of a type of good and a type of service offered by the first electronic coupon and the second electronic coupon;
associating a first plurality of coupon attributes with the first electronic coupon and a second plurality of coupon attributes with the second electronic coupon;
storing the first electronic coupon including the first plurality of coupon attributes and the second electronic coupon including the second plurality of coupon attributes in a storage device indexed by the product category;
receiving a first coupon request including a first plurality of request attributes, the first plurality of request attributes including a plurality of past attributes derived from a user history and a plurality of current attributes;
determining from a first attribute subset of the first plurality of request attributes that the first coupon request is associated with the product category;
retrieving the first electronic coupon and the second electronic coupon from the storage device using the product category in response to determining that the first coupon request is associated with the product category;
identifying a second attribute subset of the first plurality of request attributes, the second attribute subset being unique from the first attribute subset, each request attribute in the second attribute subset having a respective coupon attribute in the first plurality of coupon attributes associated with the first electronic coupon;
identifying a third attribute subset of the first plurality of request attributes, the third attribute subset being unique from the first attribute subset, each request attribute in the third attribute subset having a respective coupon attribute in the second plurality of coupon attributes associated with the second electronic coupon;
assigning a weight to each request attribute in the second attribute subset and the third attribute subset;
comparing each request attribute in the second attribute subset to its respective coupon attribute in the first plurality of coupon attributes, and each request attribute in the third attribute subset to its respective coupon attribute in the second plurality of coupon attributes;
determining a first relevancy rank between the first electronic coupon and the first coupon request based on the weight assigned to each request attribute in the second attribute subset and the comparing of each request attribute in the second attribute subset to its respective coupon attribute in the first plurality of coupon attributes;
determining a second relevancy rank between the second electronic coupon and the first coupon request based on the weight assigned to each request attribute in the third attribute subset and the comparing of each request attribute in the third attribute subset to its respective coupon attribute in the second plurality of coupon attributes;
determining that the first relevancy rank is at least one of greater than and equal to a relevancy threshold and that the second relevancy rank is less than the relevancy threshold;
transmitting the first electronic coupon as a response to the first coupon request based on determining that the first relevancy rank is at least one of greater than and equal to the relevancy threshold;
receiving a second coupon request including a second plurality of request attributes;
determining from a fourth attribute subset of the second plurality of request attributes that the second coupon request is associated with the product category;
retrieving the first electronic coupon and the second electronic coupon from the storage device using the product category in response to determining that the second coupon request is associated with the product category;
identifying a fifth attribute subset of the second plurality of request attributes, the fifth attribute subset being unique from the fourth attribute subset, each request attribute in the fifth attribute subset having a respective coupon attribute in the first plurality of coupon attributes associated with the first electronic coupon;
identifying a sixth attribute subset of the second plurality of request attributes, the sixth attribute subset being unique from the fourth attribute subset, each request attribute in the sixth attribute subset having a respective coupon attribute in the second plurality of coupon attributes associated with the second electronic coupon;
assigning a weight to each request attribute in the fifth attribute subset and the sixth attribute subset;
comparing each request attribute in the fifth attribute subset to its respective coupon attribute in the first plurality of coupon attributes, and each request attribute in the sixth attribute subset to its respective coupon attribute in the second plurality of coupon attributes;
determining a third relevancy rank between the first electronic coupon and the second coupon request based on the weight assigned to each request attribute in the fifth attribute subset and the comparing of each request attribute in the fifth attribute subset to its respective coupon attribute in the first plurality of coupon attributes;
determining a fourth relevancy rank between the second electronic coupon and the second coupon request based on the weight assigned to each request attribute in the sixth attribute subset and the comparing of each request attribute in the sixth attribute subset to its respective coupon attribute in the second plurality of coupon attributes;
determining that the fourth relevancy rank is at least one of greater than and equal to the relevancy threshold and that the third relevancy rank is less than the relevancy threshold; and
transmitting the second electronic coupon as a response to the second coupon request based on determining that the fourth relevancy rank is at least one of greater than and equal to the relevancy threshold.

11. The method for ranking the plurality of electronic coupons to determine at least one relevant electronic coupon of claim 10, further comprising:
identifying a first request attribute of the first coupon request that lies within a range of a respective second request attribute of the second coupon request; and
assigning additional weight to a third request attribute of the first coupon request and a fourth request attribute of the second coupon request in response to identifying the first and second request attributes.

12. A method for ranking a plurality of electronic coupons to determine at least one relevant electronic coupon, the at least one relevant electronic coupon being targeted to a coupon request including a plurality of request attributes, the method comprising:
storing a plurality of electronic coupons in a storage device, each electronic coupon being issued for an entity and including embedded logic for redeeming the electronic coupon from the entity;
associating a product category and a plurality of coupon attributes with each of the plurality of electronic coupons, the product category indicating at least one of a type of good and a type of service offered by the associated electronic coupon;
receiving the coupon request including the plurality of request attributes, the plurality of request attributes including a plurality of past attributes derived from a user history and a plurality of current attributes;
determining from a first attribute subset of the plurality of request attributes that the coupon request is associated with a first product category;
retrieving a first electronic coupon associated with the first product category from the storage device, the first electronic coupon being associated with a first plurality of coupon attributes;
identifying a second attribute subset of the plurality of request attributes, the second attribute subset being unique from the first attribute subset, each request attribute in the second attribute subset having a respective coupon attribute in the first plurality of coupon attributes associated with the first electronic coupon;
assigning a weight to each request attribute in the second attribute subset;
comparing each request attribute in the second attribute subset to its respective coupon attribute in the first plurality of coupon attributes;
determining a relevancy rank between the first electronic coupon and the coupon request based on the weight assigned to each request attribute in the second attribute subset and the comparing of each request attribute in the second attribute subset to its respective coupon attribute in the first plurality of coupon attributes;
determining that the relevancy rank is at least one of greater than and equal to a relevancy threshold; and
transmitting the first electronic coupon as a response to the coupon request based on determining that the relevancy rank is at least one of greater than and equal to a relevancy threshold.

13. The method for ranking the plurality of electronic coupons to determine at least one relevant electronic coupon of claim 12, wherein the second attribute subset includes a request location and its respective coupon attribute is a coupon redemption location.

14. The method for ranking the plurality of electronic coupons to determine at least one relevant electronic coupon of claim 13, wherein comparing each request attribute in the second attribute subset to its respective coupon attribute in the first plurality of coupon attributes includes determining a distance between the request location and the coupon redemption location.

15. The method for ranking the plurality of electronic coupons to determine at least one relevant electronic coupon of claim 13, further comprising:
determining a distance between the request location and a user home location, wherein the plurality of request attributes includes the user home location;
determining that the distance is greater than a predetermined distance threshold; and
assigning additional weight to the request location in response to determining that the distance is greater than the predetermined distance threshold.

16. The method for ranking the plurality of electronic coupons to determine at least one relevant electronic coupon of claim 12, wherein the second attribute subset includes a price range attribute.

17. The method for ranking the plurality of electronic coupons to determine at least one relevant electronic coupon of claim 12, wherein the second attribute subset includes a DIY attribute that is based on at least one of a user skill required and a user work required.

18. The method for ranking the plurality of electronic coupons to determine at least one relevant electronic coupon of claim 12, further comprising:
storing a plurality of user specific profiles;
grouping a subset of the plurality of user specific profiles based on a first user attribute of each user specific profile in the subset; and
assigning additional weight to a first request attribute of all coupon requests received for each user specific profile in the subset based on a group preference.

19. The method for ranking the plurality of electronic coupons to determine at least one relevant electronic coupon of claim 18, wherein the grouping is based on a location attribute of each user specific profile in the subset.

20. The method for ranking the plurality of electronic coupons to determine at least one relevant electronic coupon of claim 18, wherein the grouping is based on an age attribute of each user specific profile in the subset.
